(19) United States
(12) Patent Application Publication
(10) Pub. No.: US 2025/0218699 A1
(43) Pub. Date: Jul. 3, 2025

(54) OPERATING MECHANISM AND SWITCHING DEVICE

(71) Applicant: Chint Low Voltage Electrical Technology Co., Ltd., Songjiang District, Shanghai (CN)

(72) Inventors: Wei YAO, Songjiang District, Shanghai (CN); Denggui AO, Songjiang District, Shanghai (CN); Yongfu XU, Songjiang District, Shanghai (CN); Yue WU, Songjiang District, Shanghai (CN); Xinhua GAN, Songjiang District, Shanghai (CN); Xiaoshuang LI, Songjiang District, Shanghai (CN)

(21) Appl. No.: 18/848,847

(22) PCT Filed: Jun. 12, 2023
(86) PCT No.: PCT/CN2023/099571

§ 371 Date: Sep. 19, 2024

(30) Foreign Application Priority Data
Jun. 14, 2022 (CN) 202210668596.7

(51) Int. Cl. H01H 3/02; H01H 3/38

(52) U.S. Cl. CPC H01H 3/02; H01H 3/38

(57) ABSTRACT

The present invention relates to the field of low-voltage electric appliances, in particular to an operating mechanism and a switching device including the operating mechanism. When the operating mechanism is opened, an operating shaft drives an energy storage turntable and a transmission plate at the same time. The transmission plate moves from a transmission plate closing position to a transmission plate breaking position. The energy storage turntable drives an output shaft structure to rotate from an output shaft closing position to an output shaft breaking position. After a first spring begins to release energy, the energy storage turntable drives the output shaft structure to rotate to a breaking transition position and is disengaged from the output shaft structure after driving the output shaft structure to cross over the breaking transition position. Meanwhile, the output shaft structure is engaged with the transmission plate, such that a second spring set completes energy storage and then begins to release energy. The second spring set releases energy to drive the output shaft structure to rotate to the output shaft breaking position. According to the operating mechanism and the switching device of the present invention, an opening distance of a moving contact and a static contact can be increased significantly.

### TECHNICAL FIELD

The present invention relates to the field of low-voltage electrical appliances, and more particularly, to an operating mechanism and a switching device including the operating mechanism.

### BACKGROUND

A switching device is an electrical appliance used to switch a circuit on and off and generally includes an operating mechanism and at least one conductive device in driving connection with the operating mechanism. A contact system is arranged in the conductive device. The contact system includes a moving contact and a static contact which are used cooperatively. The moving contact and the static contact are closed or disconnected to close and open the switching device. The distance at which the moving contact and the static contact are disconnected determines the electrical performance of the switching device.

The existing switching device has the following shortcoming: a larger disconnection distance cannot be realized within a certain range of physical dimensions, which affects the improvement of the electrical performance of the product.

### SUMMARY

An object of the present invention is to overcome the defects of the prior art and provide an operating mechanism and a switching device, which can significantly increase an opening distance of a moving contact and a static contact.

In order to achieve the above object, the present invention adopts the following technical solutions:

An operating mechanism, the operating mechanism comprising:
an operating shaft, which is driven to rotate by an external force;
a transmission shaft structure;
a transmission plate, which is driven by the operating shaft to move between a transmission plate breaking position and a transmission plate closing position;
a first energy storage structure, which comprises an energy storage turntable and at least one first spring engaged with the energy storage turntable, wherein the operating shaft drives the energy storage turntable to rotate through the transmission shaft structure; during the opening and closing processes of the operating mechanism, the first spring is driven by the energy storage turntable to store energy first and then release energy, and the first spring releases energy to drive the energy storage turntable to rotate;
an output shaft structure, which is engaged with the transmission plate and the energy storage turntable, moves between an output shaft breaking position and an output shaft closing position, and is in transmission connection with a contact system of the switching device; and
a second energy storage structure, which comprises a second spring set, wherein the second spring set comprises at least one second spring with both ends respectively engaging with the transmission plate and the output shaft structure, and when the operating mechanism is opened and closed, the transmission plate and the output shaft structure cooperate to make the second spring set store energy first and then release energy;
when the operating mechanism is opened;
the operating shaft drives the energy storage turntable and the transmission plate at the same time;
the transmission plate moves from the transmission plate closing position to the transmission plate breaking position;
the energy storage turntable drives the output shaft structure to rotate from the output shaft closing position to the output shaft breaking position; after the first spring begins to release energy, the energy storage turntable drives the output shaft structure rotate to a breaking transition position and is disengaged from the output shaft structure after driving the output shaft structure to cross over the breaking transition position; meanwhile, the output shaft structure is engaged with the transmission plate, such that the second spring set completes energy storage and then begins to release energy; and
the second spring set releases energy and drives the output shaft structure to rotate to the output shaft breaking position.

Preferably, when the operating mechanism is closed:
the operating shaft drives the energy storage turntable and the transmission plate simultaneously;
the energy storage turntable rotates and drives the first spring to store energy, and meanwhile, the transmission plate moves from the transmission plate breaking position to the transmission plate closing position;
the transmission plate drives the output shaft structure to rotate from the output shaft breaking position to the output shaft closing position; when the first spring completes energy storage, the transmission plate drives the output shaft structure to rotate to a closing transition position, such that the output shaft structure is in transmission fit with the energy storage turntable; and
the first spring releases energy and drives the output shaft structure to rotate to the output shaft closing position through the energy storage turntable.

Preferably, a moving direction of the transmission plate is perpendicular to a rotational axis of the output shaft structure.

Preferably, a moving direction of the transmission plate is perpendicular to a rotational axis of the operating shaft, and a rotational axis of the output shaft structure is perpendicular to the rotational axis of the operating shaft and is parallel to a plane where the transmission plate is located.

Preferably, one end of the transmission shaft structure is in transmission fit with the operating shaft, and another end of the transmission shaft structure is in transmission fit with the energy storage turntable.

Preferably, a rotational axis of the transmission shaft structure and a rotational axis of the operating shaft are spaced in parallel.

Preferably, the transmission shaft structure comprises a first transmission shaft and a second transmission shaft that are coaxially arranged and rotate synchronously; one end of the first transmission shaft is in transmission fit with the operating shaft, and another end of the first transmission shaft is fixedly connected to or in transmission fit with the second transmission shaft; the second transmission shaft is in transmission fit with the energy storage turntable; and
the operating shaft comprises an operating shaft main body and an operating shaft first gear, wherein the operating shaft first gear is arranged on the operating shaft main body; the first transmission shaft comprises a first transmission shaft main body and a first transmission shaft gear; the first transmission shaft gear is arranged on the first transmission shaft main body; and the operating shaft first gear is meshed with the first transmission shaft gear.

Preferably, the transmission plate comprises a transmission plate toothed belt; the operating shaft comprises an operating shaft second gear; the operating shaft second gear is arranged on the operating shaft main body of the operating shaft; and the transmission plate toothed belt is meshed with the operating shaft second gear.

Preferably, the transmission plate comprises a transmission plate driving part; the output shaft structure comprises an output shaft engaging part; and the transmission plate driving part drives the output shaft structure to rotate through the output shaft engaging part.

Preferably, the transmission plate comprises a transmission plate connecting arm, one end of the second spring is rotatably connected to the transmission plate connecting arm, and another end of the second spring is rotatably connected to the output shaft structure; and
the second energy storage structure comprises two second springs, and the two second springs are arranged in parallel; each second spring comprises a second spring coil body and second spring connecting arms that are respectively arranged at both ends of the second spring coil body; one of the second spring connecting arms is rotatably connected to the output shaft structure, and another one of the spring connecting arms is rotatably connected to the transmission plate connecting arm.

Preferably, the transmission plate comprises a transmission plate main body, a transmission plate toothed belt, a transmission plate driving part and a transmission plate connecting arm; the transmission plate main body is of a frame-shaped structure; the transmission plate main body is provided with a first side edge and a second side edge which are parallel to a moving direction of the transmission plate main body; the transmission plate toothed belt is arranged on an inner side surface of the first side edge; the first side edge and the second side edge are respectively provided with a transmission plate connecting arm; the two transmission plate connecting arms are opposite to each other; the transmission plate driving part is arranged on the second side edge and is opposite to the transmission plate toothed belt; and the transmission plate driving part and the two transmission plate connecting arms are positioned on the same side of the transmission plate main body.

Preferably, the energy storage turntable comprises a turntable main body, as well as a turntable first stopper and a turntable second stopper that are respectively arranged on the turntable main body and distributed in a circumferential direction of the turntable main body; the energy storage turntable is rotatably arranged around an axis of the turntable main body; the transmission shaft structure comprises a transmission shaft shifting rod; the transmission shaft shifting rod is positioned between the turntable first stopper and the turntable second stopper; the transmission shaft shifting rod and the turntable first stopper are engaged to drive the energy storage turntable to rotate, and the energy storage turntable drives the first spring to travel from a first closed energy release position to a critical position; the transmission shaft shifting rod and the turntable second stopper are engaged to drive the energy storage turntable to rotate, and the energy storage turntable drives the first spring to travel from a first breaking energy release position to a first critical position.

Preferably, the energy storage turntable further comprises a turntable third stopper arranged on the turntable main body; the turntable first stopper, the turntable second stopper and the turntable third stopper are sequentially distributed in a circumferential direction of the turntable main body; the output shaft structure further comprises an output shaft driven part; when the operating mechanism is opened, the turntable third stopper abuts against the output shaft driven part, such that the output shaft structure rotates from the output shaft closing position to the breaking transition position; and when the operating mechanism is closed, the turntable second stopper abuts against the output shaft driven part, such that the output shaft structure rotates from the closing transition position to the output shaft closing position.

Preferably, the output shaft structure comprises a first output shaft and a second output shaft that are coaxially arranged and synchronously rotate; the first output shaft comprises a first output shaft connecting part and a first output shaft outputting part; the second output shaft comprises a second output shaft connecting part and a second output shaft outputting part; the first output shaft connecting part is fixedly connected to the second output shaft connecting part; at least one of the first output shaft outputting part and the second output shaft outputting part is used for driving connection with the contact system of the switching device.

Preferably, the output shaft structure further comprises the output shaft driven part and an output shaft engaging part, and the output shaft driven part and the output shaft engaging part are respectively arranged on the first output shaft connecting part and are distributed in a circumferential direction of the first output shaft connecting part.

A switching device, wherein the switching device comprises the operating mechanism.

With the operating mechanism of the present invention, the output shaft structure rotates from the output shaft closing position to the breaking transition position under the action of the first spring and then crosses over the breaking transition position, and then rotates to the output shaft breaking position under the action of the second spring, thereby increasing the rotation angle of the output shaft structure, also increasing the opening distance between the moving contact and the static contact of the contact system in driving connection with the output shaft structure accordingly, and improving an electrical performance.

A switching device of the present invention includes the operating mechanism, which increases the opening distance between the moving contact and the static contact of the contact system, thereby improving the electrical performance of the switching device.

### BRIEF DESCRIPTION OF THE DRAWINGS

FIG. 1 is a schematic structural diagram of an operating mechanism in the present invention;

FIG. 2 is a schematic structural diagram of the operating mechanism in a closed state in the present invention;

FIG. 3 is a schematic structural diagram of the operating mechanism in an opened state in the present invention;

FIG. 4 is a schematic structural diagram of the operating mechanism in the present invention, in which a first spring is located in a first closed energy release position;

FIG. 5 is a schematic structural diagram of the operating mechanism in the present invention, in which the first spring is located in a first breaking energy release position;

FIG. 6 is a schematic structural diagram of an operating shaft in the present invention;

FIG. 7 is a schematic structural diagram of a first transmission shaft in the present invention;

FIG. 8 is a schematic structural diagram of a second transmission shaft in the present invention;

FIG. 9 is a schematic structural diagram of a transmission plate in the present invention;

FIG. 10 is a schematic structural diagram of a first output shaft from one perspective in the present invention;

FIG. 11 is a schematic structural diagram of the first output shaft from another perspective in the present invention;

FIG. 12 is a schematic structural diagram of a energy storage turntable from one perspective in the present invention;

FIG. 13 is a schematic structural diagram of the energy storage turntable from another perspective in the present invention;

FIG. 14 is a schematic structural diagram of a second output shaft from one perspective in the present invention;

FIG. 15 is a schematic structural diagram of the second output shaft from another perspective in the present invention;

FIG. 16 is a schematic structural diagram of a first spring in the present invention; and

FIG. 17 is a schematic structural diagram of a second spring in the present invention.

### DETAILED DESCRIPTION OF THE INVENTION

The specific implementations of an operating mechanism and a switching device of the present invention will be further described below in conjunction with the embodiments given in the accompanying drawings of the specification. The operating mechanism and the switching device of the present invention are not limited to the description of the following embodiments.

The present invention discloses an operating mechanism, including:
an operating shaft 20-1, which is driven to rotate by an external force to drive the operating mechanism to open and close;
a transmission shaft structure;
a transmission plate 20-3, which is driven by the operating shaft 20-1 to move between a transmission plate breaking position and a transmission plate closing position;
a first energy storage structure, which includes an energy storage turntable 20-5 and at least one first spring 20-8 engaged with the energy storage turntable 20-5, wherein the operating shaft 20-1 drives the energy storage turntable 20-5 to rotate through the transmission shaft structure; during the opening and closing processes of the operating mechanism, the first spring 20-8 is driven by the energy storage turntable 20-5 to store energy first and then release energy, and the first spring 20-8 releases energy to drive the energy storage turntable 20-5 to rotate;
an output shaft structure, which is engaged with the transmission plate 20-3 and the energy storage turntable 20-5, moves between an output shaft breaking position and an output shaft closing position, and is in transmission connection with a contact system of the switching device so as to switch the contact system between a breaking state and a closed state; and
a second energy storage structure, which includes a second spring set, wherein the second spring set includes at least one second spring 30 with both ends engaging with the transmission plate 20-3 and the output shaft structure respectively, and when the operating mechanism is opened and closed, the transmission plate 20-3 and the output shaft structure cooperate to make the second spring 30 store energy first and then release energy;
when the operating mechanism is opened:
the operating shaft 20-1 drives the energy storage turntable 20-5 and the transmission plate 20-3 simultaneously;
the transmission plate 20-3 moves from the transmission plate closing position to the transmission plate breaking position;
the energy storage turntable 20-5 drives the output shaft structure to rotate from the output shaft closing position to the output shaft breaking position; after the first spring 20-8 begins to release energy; the energy storage turntable 20-5 drives the output shaft structure rotate to a breaking transition position and is disengaged from the output shaft structure after driving the output shaft structure to cross over the breaking transition position; meanwhile, the output shaft structure and the transmission plate 20-3 cooperate to make the second spring set complete energy storage and then begin to release energy; and
the second spring set releases energy and drives the output shaft structure to rotate to the output shaft breaking position.

With the operating mechanism of the present invention, the output shaft structure rotates from the output shaft closing position to the breaking transition position under the action of the first spring and then crosses over the breaking transition position, and then rotates to the output shaft breaking position under the action of the second spring, thereby increasing a rotation angle of the output shaft structure, also increasing an opening distance of a moving contact and a static contact accordingly, and improving an electrical performance.

When the operating mechanism in this embodiment is closed;
the operating shaft 20-1 drives the energy storage turntable 20-5 and the transmission plate 20-3 simultaneously;
the energy storage turntable 20-5 rotates and drives the first spring 20-8 to store energy, and meanwhile, the transmission plate 20-3 moves from the transmission plate breaking position to the transmission plate closing position;
the transmission plate 20-3 drives the output shaft structure to rotate from the output shaft breaking position to the output shaft closing position, when the first spring 20-8 completes energy storage, the transmission plate 20-3 drives the output shaft structure to rotate to a closing transition position, such that the output shaft structure restores to be in transmission fit with the energy storage turntable 20-5;
the transmission plate 20-3 and the output shaft structure cooperate to make the second spring set first store energy and then release energy, and the second spring set releases energy and drives the output shaft structure to rotate to the output shaft closing position; and the first spring 20-8 releases energy and drives the output shaft structure to rotate to the output shaft closing position through the energy storage turntable 20-5.

That is, in the closing process, after the first spring 20-8 completes energy storage and begins to release energy, the output shaft structure is driven to rotate by the first spring 20-8 till the output shaft rotates to the output shaft closing position, and the output shaft structure rotates to the output shaft closing position under a main driving force provided by the first spring 20-8. thereby ensuring the closing speed. In the said process, the second spring set may release energy together with the first spring 20-8 to drive the output shaft structure to rotate to the output shaft closing position, or the energy releasing may also be completed before the output shaft structure rotates to the output shaft closing position.

During the closing process of the operating mechanism in this embodiment, in order to ensure the closing speed, a driving force is mainly provided by the energy release of the first spring 20-8. However, in the last stage of the opening process, the first spring 20-8 already has completed the energy release, and the second spring set has not completed the energy release, done by the energy release of the second spring set alone, so that a closing speed in the closing process is ensured and ensuring an opening distance in an opening process. A driving force by the energy release of the first spring 20-8 is much greater than a driving force by the energy release of the second spring set.

During the opening and closing processes of the operating mechanism in this embodiment, the operating shaft 20-1 rotates in two opposite directions, respectively.

The present invention discloses a switching device. The switching device includes an operating mechanism and at least one contact system. The operating mechanism is in driving connection with the contact system in order to drive the contact system to be closed or disconnected. The contact system includes a moving contact and a static contact that are used cooperatively. The operating mechanism is in driving connection with the moving contact in order to drive the moving contact and the static contact to be closed or disconnected. A plurality of contact systems may be provided. The number of the contact system can be multiple, the plurality of contact systems is stacked and driven in sequence. The output shaft structure of the operating mechanism is in driving connection with the topmost contact system and drive the plurality of contact systems to be closed or disconnected at the same time.

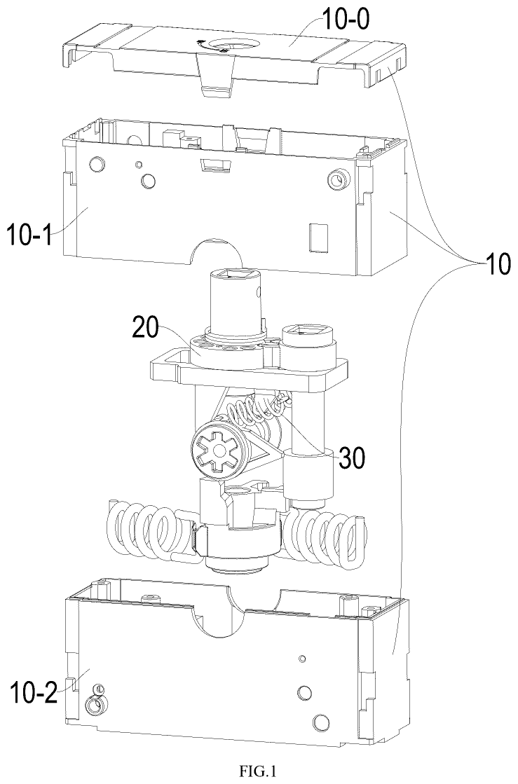

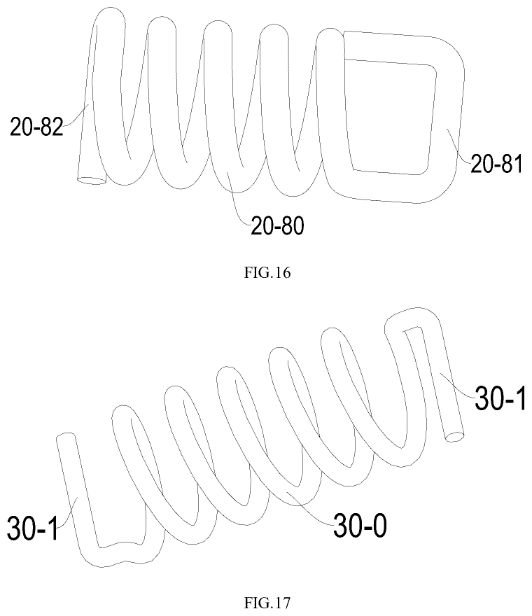

An embodiment of the operating mechanism of the present invention is shown in FIGS. 1-17.

As shown in FIGS. 1-3, the operating mechanism in this embodiment includes a mechanism support 10, an operating structure, a first energy storage structure, a second energy storage structure and an output shaft structure.

The mechanism support 10 may be of a closed, semi-closed or open structure, may be of an independent structure or a housing of the switching device may also be used as the mechanism support 10.

As shown in FIG. 1, in the operating mechanism in this embodiment, the mechanism support 10 is preferably an independent operating mechanism housing, which includes a support cover 10-0, a support pedestal 10-1 and a support base 10-2 that are sequentially buckled together from top to bottom. The operating structure, the first energy storage structure, the second energy storage structure and the output shaft structure are all arranged between the support pedestal 10-1 and the support base 10-2. The operation shaft 20-1 of the operating structure passes through the support pedestal 10-1 and the support cover 10-0 in sequence for an operator to operate, so as to drive the operating shaft 20-1 to rotate.

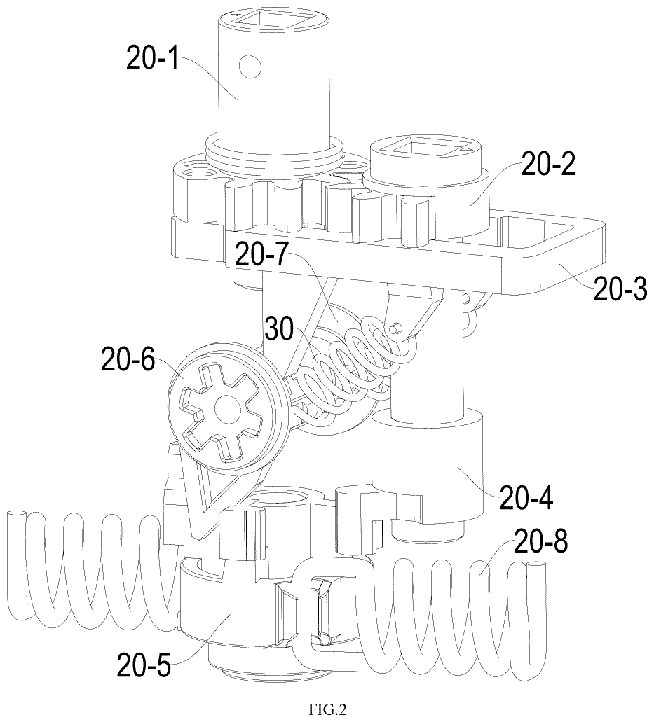

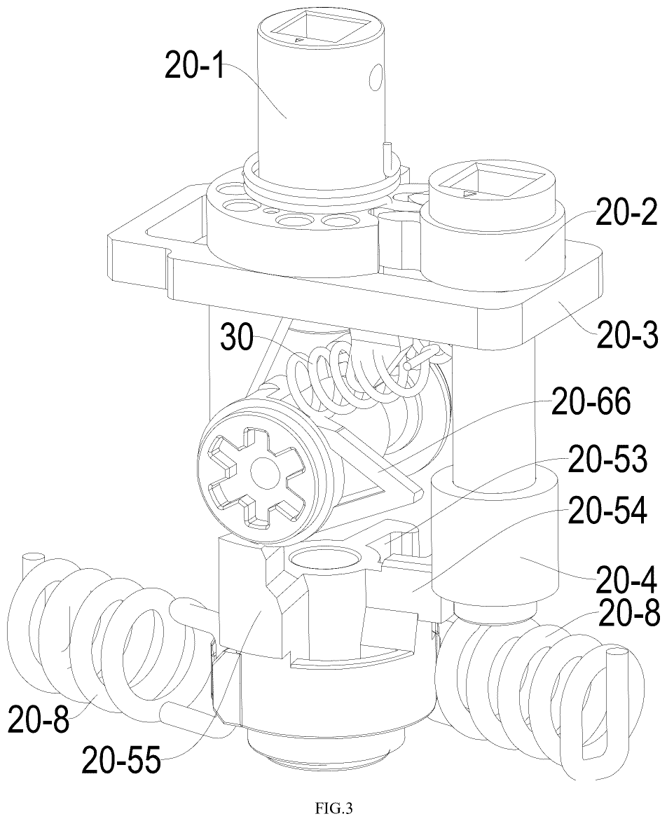

As shown in FIGS. 2-3, the operating structure includes an operating shaft 20-1, a transmission shaft structure and a transmission plate 20-3. The transmission shaft structure in this embodiment includes a first transmission shaft 20-2 and a second transmission shaft 20-4 which rotate synchronously. The operating shaft 20-1 rotates around its own axis. The operating shaft 20-1 is in transmission fit with the transmission shaft structure so as to drive the transmission shaft structure to rotate. The transmission plate 20-3 is driven by the operating shaft 20-1 to reciprocate, and the transmission plate 20-3 is also in transmission fit with the output shaft structure. The operating shaft 20-1 drives the energy storage turntable 20-5 of the first energy storage structure to rotate through the transmission shaft structure.

As shown in FIGS. 2-3, a moving direction of the transmission plate 20-3 is perpendicular to a rotational axis of the output shaft structure.

As shown in FIGS. 2-3, the moving direction of the transmission plate 20-3 is perpendicular to a rotational axis of the operating shaft 20-1, and the rotational axis of the output shaft structure is perpendicular to the rotational axis of the operating shaft 20-1 and is parallel to a plane where the transmission plate 20-3 is located. Further, the moving direction of the transmission plate 20-3, the rotational axis of the operating shaft 20-1 and the rotational axis of the output shaft structure are parallel to x, y, z axes of a coordinate system, respectively.

As shown in FIGS. 2-3, rotational axes of the operating shaft 20-1 and the transmission shaft structure are spaced in parallel.

As shown in FIGS. 2-3, the transmission shaft structure rotates around its own axis, one end of the transmission shaft structure is in transmission fit with the operating shaft 20-1, and the other end of the transmission shaft structure is in transmission fit with the energy storage turntable 20-5 of the first energy storage structure.

As shown in FIGS. 2-3, the transmission plate 20-3 has a transmission plate closing position and a transmission plate breaking position, and the operating shaft 20-1 drives the transmission plate 20-3 to move to switch between the above two working positions.

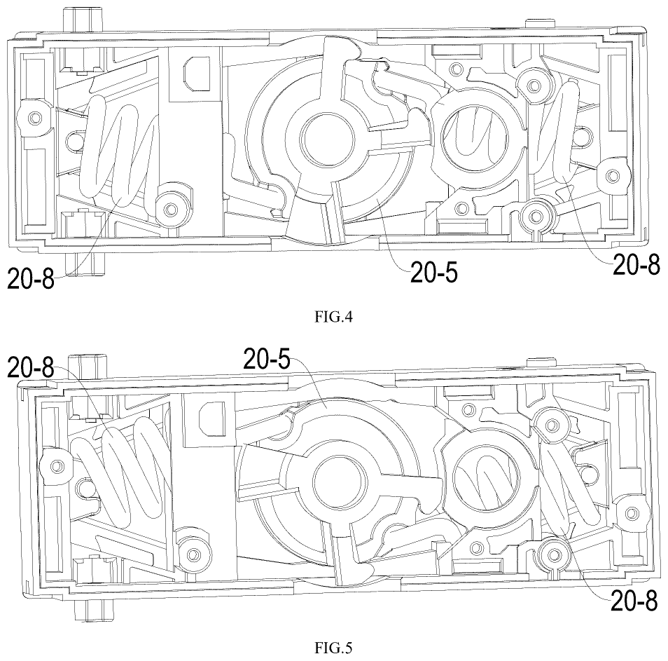

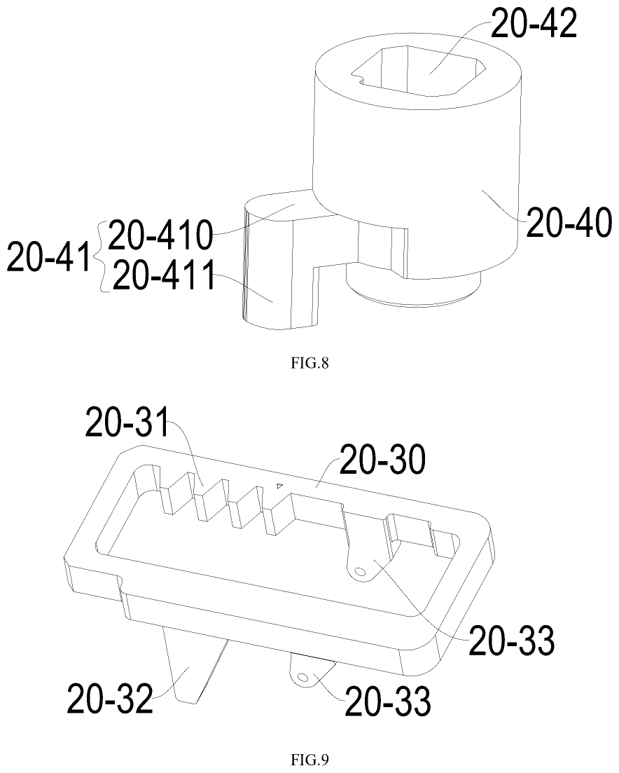

As shown in FIG. 6, the operating shaft 20-1 includes an operating shaft main body 20-10 and an operating shaft second gear 20-12. The operating shaft second gear 20-12 is arranged on and coaxial with the operating shaft main body 20-10. As shown in FIG. 9, the transmission plate 20-3 includes a transmission plate toothed belt 20-31, and the transmission plate toothed belt 20-31 is in meshing fit with the operating shaft second gear 20-12. The operating shaft 20-1 rotates. Through the meshing fit of the operating shaft second gear 20-12 and the transmission plate toothed belt 20-31, the transmission plate 20-3 is driven to reciprocate by the operating shaft 20-1 in order to switch between the transmission plate closing position and the transmission plate breaking position. The operating shaft 20-1 and the transmission plate 20-3 in this embodiment cooperate with each other through a gear-transmission manner, which can improve the transmission accuracy and achieve high reliability.

As shown in FIGS. 2-3, the operating shaft 20-1 preferably rotates around an axis of the operating shaft main body 20-10. The operating shaft second gear 20-12 is coaxial with the operating shaft main body 20-10.

As shown in FIG. 9, the transmission plate 20-3 includes a transmission plate main body 20-30. The transmission plate main body 20-30 is of a frame-shaped structure, wherein the transmission plate toothed belt 20-31 is arranged on an inner side surface of one side edge of the transmission plate main body 20-30, and the operating shaft 20-1 and the transmission shaft structure are respectively plugged in the transmission plate main body 20-30, thereby achieving a compact structure and reducing the overall volume of the operating mechanism. Of course, as other embodiments, the transmission plate toothed belt 20-31 may also be arranged on an outside the transmission plate main body 20-30.

As shown in FIGS. 2-3, and 7-8, the transmission shaft structure in this embodiment includes a first transmission shaft 20-2 and a second transmission shaft 20-4 that rotate synchronously; one end of the first transmission shaft 20-2 is in transmission fit with the operating shaft 20-1, and the other end of the first transmission shaft 20-2 is in transmission fit with the second transmission shaft 20-4; and the second transmission shaft 20-4 is in transmission fit with the energy storage turntable 20-5. Further, the first transmission shaft 20-2 is coaxial with and fixedly connected to the second transmission shaft 20-4, both of which are of an integrated or split structure.

As shown in FIGS. 2-3, and 7-8, the operating shaft 20-1 includes an operating shaft main body 20-10 and an operating shaft first gear 20-11 that is coaxial with the operating shaft main body 20-10. The first transmission shaft 20-2 includes a first transmission shaft main body 20-20 and a first transmission shaft gear 20-21. The first transmission shaft gear 20-21 is arranged on and coaxial with the first transmission shaft main body 20-20. The operating shaft first gear 20-11 is meshed with the first transmission shaft gear 20-21. Further, both the operating shaft first gear 20-11 and the first transmission shaft gear 20-21 are fan-shaped gears.

As shown in FIGS. 2-3, the first transmission shaft 20-20 preferably rotates around an axis of the first transmission shaft main body 20-20.

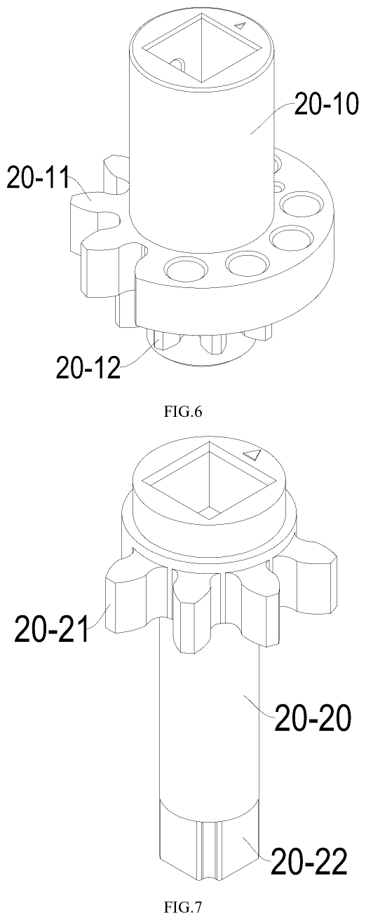

As shown in FIG. 7, the first transmission shaft 20-2 further includes a first transmission shaft plug-in end 20-22 arranged at one end of the first transmission shaft main body 20-0, and the first transmission shaft gear 20-21 and the first transmission shaft plug-in end 20-22 are respectively located at both ends of the first transmission shaft main body 20-20. As shown in FIG. 8, the second transmission shaft 20-4 includes a second transmission shaft main body 20-40, and a second transmission shaft slot 20-42 is formed in one end of the second transmission shaft main body 20-40. The first transmission shaft plug-in end 20-22 is plugged in and in limiting fit with the second transmission shaft slot 20-42 so as to prevent the first transmission shaft 20-2 and the second transmission shaft 20-4 from rotating relative to each other, thereby ensuring that the first transmission shaft 20-2 and the second transmission shaft 20-4 rotate synchronously.

As other embodiments, the first transmission shaft 20-2 and the second transmission shaft 20-4 may also be of split structures, and rotation axes of the first transmission shaft 20-2 and the second transmission shaft 20-4 are spaced in parallel. One end of the first transmission shaft 20-2 is in transmission fit with the operating shaft 20-1, and the other end of the first transmission shaft 20-2 is in transmission fit with the second transmission shaft 20-4. That is, the operating shaft 20-1 rotates to drive the first transmission shaft 20-2 to rotate, and the first transmission shaft 20-2 synchronously drives the second transmission shaft 20-4 to rotate.

As shown in FIGS. 2-5, the first energy storage structure includes an energy storage turntable 20-5 arranged around its own axis, and at least one first spring 20-8. Both ends of the first spring 20-8 are respectively engaged with the energy storage turntable 20-5 and the mechanism support 10 and the first spring 20-8 has a first closed energy release position, a first critical position and a first breaking energy release position sequentially arranged. The energy storage turntable 20-5 rotates and drives the first spring 20-8 to travel from the first closed energy release position or the first breaking energy release position to the first critical position for energy storage. That is, when the operating mechanism is opened, the energy storage turntable 20-5 drives the first spring 20-8 to travel from the first closed energy release position to the first critical position for energy storage, and when the operating mechanism is opened. the energy storage turntable 20-5 drives the first spring 20-8 to travel from the first breaking energy release position to the first critical position for energy storage. The first spring 20-8 travels to the first closed energy release position or the first breaking energy release position across the first critical position, that is, when the operating mechanism is closed, the first spring 20-8 travels to the first closed energy release position across the first critical position; and when the operating mechanism is opened, the first spring 20-8 travels to the first breaking energy release position across the first critical position, in order to release energy to drive the energy storage turntable 20-5 to rotate, i.e., the first spring 20-8 stores energy first and then releases energy regardless during the closing or opening process of the operating mechanism. When the first spring 20-8 is at the first critical position. both ends of the first spring 20-8 and the rotational axis of the energy storage turntable 20-5 are located on the same plane, the end of the first spring 20-8 engaged with the mechanism support 10 is a first spring support end. The first spring 20-8 swings with the first spring support end as a fulcrum, and is switched among the first closed energy release position, the first critical position and the first break energy release position in sequence. The energy storage turntable 20-5 rotates and drives the first spring 20-8 to cross over the first critical position, and the energy storage is the largest when the first spring 20-8 is at the first critical position, that is, the first spring 20-8 completes energy storage when moving to the first critical position.

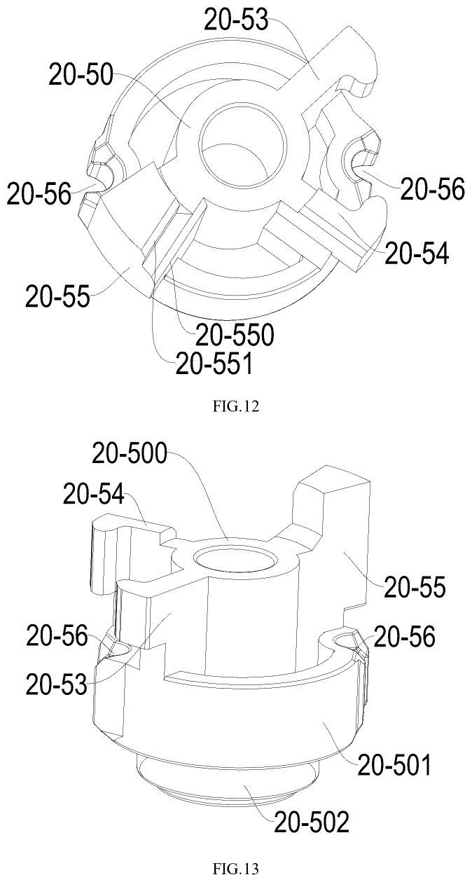

As shown in FIGS. 2-5, the first energy storage structure includes two first springs 20-8, wherein one ends of the two first springs 20-8 are engaged with two radial ends of the energy storage turntable 20-5 respectively, and the other ends of the two first springs 20-8 are engaged with the mechanism supports 10 respectively. Further, as shown in FIGS. 12-13, and 16, the energy storage turntable 20-5 includes two turntable spring grooves 20-56 respectively formed in two radial ends of the energy storage turntable. The first spring 20-8 is a compression spring and includes a first spring coil body 20-80, as well as a first spring inner arm 20-82 and a first spring outer arm 20-81 which are arranged at both ends of the first spring coil body 20-80 respectively. The first spring inner arm 20-82 and the first spring outer arm 20-81 are arranged in parallel and are both perpendicular to an axis of the first spring coil body 20-80. The first spring inner arm 20-82 is rotatably arranged in the turntable spring groove 20-56, and the first spring outer wall 20-81 is rotatably arranged on the mechanism support 10.

As other embodiments, the first spring 20-8 may also be a torsion spring, and both ends of the torsion spring are engaged with the energy storage turntable 20-5 and the mechanism support 10, respectively.

As shown in FIGS. 2-3, 8 and 12-13, the second transmission shaft 20-4 of the transmission shaft structure includes a transmission shaft shifting rod 20-41. The energy storage turntable 20-5 includes a turntable main body 20-50, as well as a turntable first stopper 20-53 and a turntable second stopper 20-54 which are respectively arranged on the turntable main body 20-50 and distributed in a circumferential direction of the turntable main body 20-50. The energy storage turntable 20-5 is rotatably arranged around an axis of the turntable main body 20-50. The transmission shaft shifting rod 20-41 is located between the turntable first stopper 20-53 and the turntable second stopper 20-54. The transmission shaft shifting rod 20-41 swings to be engaged with the turntable first stopper 20-53 and the turntable second stopper 20-54 respectively so as to drive the energy storage turntable 20-5 to rotate. The transmission shaft shifting rod 20-41 and the turntable first stopper 20-53 are engaged to drive the energy storage turntable 20-5 to rotate, and the energy storage turntable 20-5 drives the first spring 20-8 to travel from the first closed energy release position to the first critical position. The transmission shaft shifting rod 20-41 and the turntable second stopper 20-54 are engaged to drive the energy storage turntable (20-5) to rotate, and the energy storage turntable 20-5 drives the first spring 20-8 to travel from the first breaking energy release position to the first critical position.

As shown in FIG. 8, the transmission shaft shifting rod 20-41 is of an L-shaped structure, and includes a shifting rod connecting part 20-410 and a shifting rod shifting part 20-411. Both ends of the shifting rod connecting part 20-410 are connected to the second transmission shaft main body 20-40 of the second transmission shaft 20-4 and the shifting rod shifting part 20-411, respectively. The shifting rod shifting part 20-411 is located between the turntable first stopper 20-53 and the turntable second stopper 20-54. An extension direction of the shifting rod shifting part is parallel to a rotational axis of the second transmission shaft 20-4.

As shown in FIGS. 2-3, the second energy storage structure includes a second spring set, wherein the second spring set includes at least one second spring 30 both ends of which are engaged with the transmission plate 20-3 and the output shaft structure, respectively. When the operating mechanism is opened and closed, the transmission plate 20-3 and the output shaft structure cooperate to make the second spring set store energy first and then release energy. Further, the second spring set includes a second closed energy release position, a second breaking energy release position, a closing critical position and a breaking critical position. When the operating mechanism is closed, the transmission plate 20-3 and the output shaft structure cooperate to make the second spring set travel from the second breaking energy release position to the closing critical position for energy storage, the transmission plate 20-3 and the output shaft structure cooperate to make the second spring set cross over the closing critical position and release energy to drive the output shaft structure to rotate to the output shaft breaking position. When the operating mechanism is opened, the transmission plate 20-3 and the output shaft structure cooperate to make the second spring set travel from the second closed energy release position to the breaking critical position for energy storage, the transmission plate 20-3 and the output shaft structure cooperate to make the second spring set cross over the breaking critical position and release energy to drive the output shaft structure to rotate to the output shaft closing position, i.e., the second spring set stores energy first and then releases energy regardless during the closing or opening process of the operating mechanism.

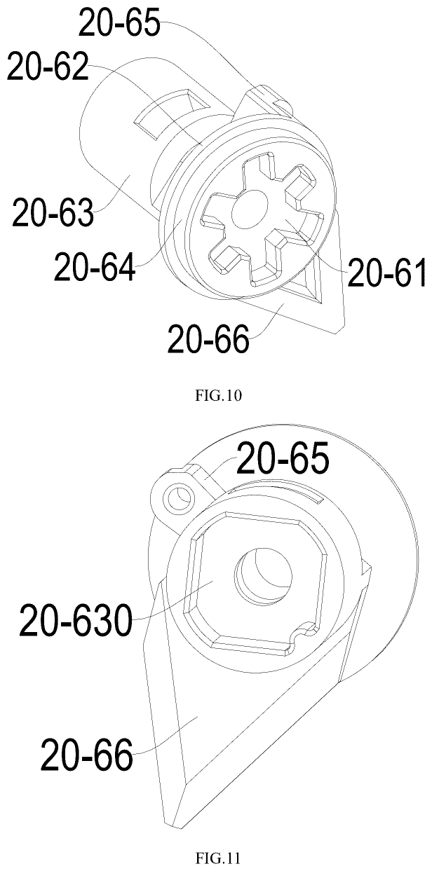

As shown in FIGS. 2-3, the second energy storage structure includes two second springs 30 which are arranged in parallel. As shown in FIG. 17, the second spring is a compression spring. Each second spring 30 includes a second spring coil body 30-0, and second spring connecting arms 30-1 that are respectively arranged at both ends of the second spring coil body 30-0. One of the second spring connecting arms 30-1 is rotatably connected to the output shaft structure, and the other one of second spring connecting arms 30-1 is rotatably connected to the transmission plate 20-3. Further, as shown in FIG. 9, the transmission plate 20-3 includes a transmission plate connecting arm 20-33, and the transmission plate connecting arm 20-33 is provided with a transmission plate connecting hole. As shown in FIGS. 10-11, and 14-15, the output shaft structure includes output shaft connecting arms 20-65 and 20-75, and the output shaft connecting arms 20-65 and 20-75 extend in a radial direction of the output shaft structure and are provided with output shaft connecting holes. As shown in FIGS. 2-3, for the two second spring connecting arms 30-1 of each second spring 30, one of the second spring connecting arms 30-1 is rotatably plugged in the output shaft connecting hole, and the other second spring connecting arm 30-1 is rotatably plugged in the transmission plate connecting hole. Further, the two second springs 30 are spaced side by side, and the axes of the two second springs 30 are arranged in parallel.

As other embodiments, the two second springs 30 are distributed in a V-shape, wherein both ends of one second spring 30 are rotatably connected to the first output shaft 20-6 and the transmission plate 20-3 respectively, and both ends of the other second spring 30 are rotatably connected to the second output shaft 20-7 and the transmission plate 20-3 respectively. One end of the two second springs 30 which are connected to the transmission plate 20-3 are arranged at both ends of the transmission plate 20-3 in a moving direction, respectively.

A torque of the second spring 30 is less than a torque provided by the first spring 20-8 to the second spring 30 via the energy storage turntable 20-5 and the output shaft structure, such that the operating mechanism only needs to overcome a smaller reaction force of the second spring 30 in the initial stage of opening, which ensures a disconnection speed of the moving contact and the static contact, and improves the electrical performance.

As other embodiments, the second spring 30 may also be a torsion spring, and both ends of the torsion spring are rotatably connected to the transmission plate 20-3 and the output shaft structure respectively.

As shown in FIGS. 2-3, and 9, for the transmission plate main body 20-30 of the transmission plate 20-3, a pair of side edges of the transmission plate main body 20-30 are provided with a transmission plate connecting arm 20-33, respectively, the two transmission plate connecting arms 20-33 are located on the same side of the transmission plate main body 20-30, and a connecting line between the two transmission plate connecting arms 20-33 is perpendicular to the moving direction of the transmission plate 20-3.

As shown in FIGS. 2-3, the output shaft structure is rotatably arranged around its own axis and is used for driving connection with the contact system of the switching device in order to drive the contact system to be closed or disconnected, that is, the contact system is switched between a closed state and a disconnected state. The output shaft structure has an output shaft breaking position, a closing transition position (not shown), a breaking transition position (not shown) and an output shaft closing position.

As shown in FIGS. 2-3, when the transmission plate 20-3 moves from the transmission plate breaking position to the transmission plate closing position, the output shaft structure is driven to rotate from the output shaft breaking position to the closing transition position. Further, as shown in FIGS. 2-3, and 9, the transmission plate 20-3 includes a transmission plate driving part 20-32, and the output shaft structure includes an output shaft engaging part. The output shaft connecting arm 20-65 is used as the output shaft engaging part. When the transmission plate 20-3 moves from the transmission plate breaking position to the transmission plate closing position, the transmission plate 20-3 abuts against the output shaft engaging part through the transmission plate driving part 20-32, such that the output shaft structure rotates from the output shaft breaking position to the closing transition position.

As shown in FIG. 9, the transmission plate driving part 20-32 is arranged on one side edge of the transmission plate main body 20-30, and the transmission plate driving part 20-32 and the transmission plate connecting arm 20-33 are located at the same side of the transmission plate main body 20-30. The transmission plate main body 20-30 is provided with a first side edge and a second side edge which are parallel to its moving direction. The transmission plate toothed belt 20-31 and one transmission plate connecting arm 20-33 are arranged on the first side edge, and the transmission plate driving part 20-32 and the other transmission plate connecting arm 20-33 are arranged on the second side edge. The transmission plate toothed belt 20-31 is opposite to the transmission plate driving part 20-32.

As shown in FIGS. 2-3, when the output shaft structure rotates from the breaking transition position to the output shaft breaking position, the output shaft structure is in limiting fit with the transmission plate 20-3 to prevent the output shaft structure from continuing rotating. Further, the output shaft engaging part is in limiting fit with the transmission plate driving part 20-32 to prevent the output shaft structure from continuing rotating.

As shown in FIGS. 12-13, the energy storage turntable 20-5 further includes a turntable third stopper 20-55. The turntable first stopper 20-53, the turntable second stopper 20-54 and the turntable third stopper 20-55 are sequentially distributed in a circumferential direction of the turntable main body 20-50. As shown in FIGS. 2-3, and 10-11, the output shaft structure further includes an output shaft driven part 20-66, and the output shaft driven part 20-66 is engaged with the turntable second stopper 20-54 and the turntable third stopper 20-55 respectively. When the operating mechanism is opened, the turntable third stopper 20-55 abuts against the output shaft driven part 20-66, such that the output shaft structure rotates from the output shaft closing position to the breaking transition position; and when the operating mechanism is closed, the turntable second stopper 20-54 abuts against the output shaft driven part 20-66, such that the output shaft structure rotates from the closing transition position to the output shaft closing position.

As shown in FIG. 12, the turntable third stopper 20-55 includes a stopper first driving surface 20-550 and a stopper second driving surface 20-551 which are engaged with the output shaft driven part 20-66, respectively. When the turntable third stopper 20-55 abuts against the output shaft driven part 20-66, the stopper first driving surface 20-550 and the stopper second driving surface 20-551 are engaged with the output shaft driven part 20-66 in sequence. When the operating mechanism is opened, the stopper first driving surface 20-550 and the stopper second driving surface 20-551 are engaged with the output shaft driven part 20-66 in sequence, such that the output shaft structure rotates to the opening transition position, and the stopper second driving surface 20-551 is disengaged from the output shaft driven part 20-66 when the output shaft structure is driven to cross over the opening transition position by the stopper second driving surface 20-551. Further, the stopper first driving surface 20-550 and the stopper second driving surface 20-551 are spaced in an axial direction of the energy storage turntable 20-55, and the stopper first driving surface 20-550, the stopper second driving surface 20-551, the turntable second stopper 20-54 and the turntable first stopper 20-51 are arranged sequentially in a circumferential direction of the turntable main body 20-50.

As shown in FIGS. 12-13, the turntable main body 20-50 includes a turntable main body first section 20-500 and a turntable main body second section 20-501 that are sequentially connected in its axial direction. The turntable first stopper 20-53, the turntable second stopper 20-54 and the turntable third stopper 20-55 are all arranged on the turntable main body first section 20-500 and are sequentially distributed in a circumferential direction of the turntable main body first section 20-500. The two turntable spring grooves 20-56 are formed in two radial ends of the turntable main body second section 20-501. Further, the turntable main body 20-50 also includes a turntable main body third section 20-502. The turntable main body first section 20-500, the turntable main body second section 20-501 and the turntable main body third section 20-502 are sequentially connected in an axial direction of the turntable main body 20-50. The turntable main body 20-50 is rotatably arranged on the mechanism support 10 through the turntable main body third section 20-502. Further, an outer diameter of the turntable main body second section 20-501 is greater than an outer diameter of the turntable main body first section 20-501 and an outer diameter of the turntable main body third section 20-502.

As shown in FIGS. 10-11, the output shaft driven part 20-66 is of a wedge-shaped structure, and includes a driven part first side and a driven part second side that are distributed in a V-shape and are engaged with the turntable second stopper 20-54 and the turntable third stopper 20-55 respectively. That is, the turntable second stopper 20-54 abuts against the driven part first side, such that the output shaft structure rotates from the closing transition position to the output shaft closing position. The turntable third stopper 20-55 abuts against the driven part second side, such that the output shaft structure rotates from the output shaft closing position to the breaking transition position.

As shown in FIGS. 10-11, and 14-15, wherein the output shaft structure includes a first output shaft 20-6 and a second output shaft 20-7 that are coaxially arranged and synchronously rotate. The first output shaft 20-6 includes a first output shaft connecting part 20-63 and a first output shaft outputting part 20-64. The second output shaft 20-7 includes a second output shaft connecting part 20-73 and a second output shaft outputting part 20-74. The first output shaft connecting part 20-63 is fixedly connected to the second output shaft connecting part 20-73. The first output shaft outputting part 20-64 and the second output shaft outputting part 20-74 are rotatably arranged on the housing support 10 respectively, and at least one of the first output shaft outputting part 20-64 and the second output shaft outputting part 20-74 is in driving connection with the contact system of the switching device. Each of the first output shaft connecting part 20-63 and the second output shaft connecting part 20-73 is provided with an output shaft connecting arm, i.e., a first output shaft connecting arm 20-65 and a second output shaft connecting arm 20-75 respectively. The first output shaft connecting arm 20-65 extends in a radial direction of the first output shaft connecting part 20-63, and the second output shaft connecting arm 20-75 extends in a radial direction of the second output shaft connecting part 20-73. The first output shaft connecting arm 20-65 and the second output shaft connecting arm 20-75 are rotatably connected to one ends of the two second springs 30 respectively.

As shown in FIGS. 2-3, the first output shaft connecting arm 20-65 is used as the output shaft engaging part and is engaged with the transmission plate driving part 20-32 of the transmission plate 20-3.

As shown in FIGS. 2-3, and 10-11, a large-diameter end of the output shaft driven part 20-66 is connected to the first output shaft connecting part 20-63, and a tip of the output shaft driven part 20-66 is engaged with the turntable second stopper 20-54 and the turntable third stopper 20-55, respectively.

As shown in FIG. 10, a free end of the first output shaft outputting part 20-64 is provided with a first output shaft engaging groove 20-61 for driving fit with the contact system. As shown in FIG. 15, a free end of the second output shaft outputting part 20-74 is provided with a second output shaft engaging groove 20-71 which is used for driving fit with the contact system.

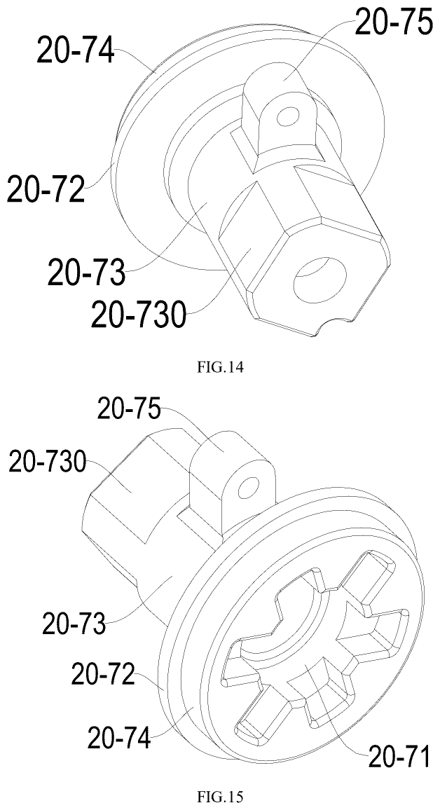

As shown in FIG. 11, a free end of the first output shaft connecting part 20-63 is provided with a first output shaft slot 20-630. As shown in FIGS. 14-15, a free end of the second output shaft connecting part 20-73 is provided with a second output shaft plug 20-730. The second output shaft plug 20-730 is plugged in and in limiting fit with the first output shaft slot 20-630, in order to prevent the first output shaft 20-6 and the second output shaft 20-7 from rotating relative to each other, thereby ensuring that the first output shaft 20-6 and the second output shaft 20-7 rotate synchronously.

As other embodiments, the first output shaft connecting part 20-63 and the second output shaft connecting part 20-73 may also be fixedly connected through a connector, for example, connected through a connecting shaft, and both ends of the connecting shaft are in pluggable fit with the first output shaft connecting part 20-63 and the second output shaft connecting part 20-73 respectively.

As shown in FIGS. 10-11, the first output shaft 20-6 further includes a first output shaft limiting part 20-62; the first output shaft connecting part 20-63, the first output shaft limiting part 20-62 and the first output shaft outputting part 20-64 are sequentially connected and coaxially arranged. An outer diameter of the first output shaft limiting part 20-62 is greater than an outer diameter of the first output shaft connecting part 20-63 and an outer diameter of the first output shaft outputting part 20-64. As shown in FIGS. 14-15, the second output shaft 20-7 further includes a second output shaft limiting part 20-72; the second output shaft connecting part 20-73, the second output shaft limiting part 20-72 and the second output shaft outputting part 20-74 are connected sequentially and coaxially arranged. An outer diameter of the second output shaft limiting part 20-72 is greater than an outer diameter of the second output shaft connecting part 20-73 and an outer diameter of the second output shaft outputting part 20-74. The first output shaft limiting part 20-62 and the second output shaft limiting part 20-72 are respectively in limiting fit with a pair of side walls of the mechanism support 10, which ensures the reliable connection of the first output shaft 20-6 and the second output shaft 20-7, and also prevents the first output shaft 20-6 and the second output shaft 20-7 from coming out of the mechanism support 10.

As shown in FIGS. 2-3, when the operating mechanism is opened, an action process is as follows.
01: the operating shaft 20-1 rotates in an opening direction and drives the energy storage turntable 20-5 to rotate through the transmission shaft structure (i.e., the first transmission shaft 20-2 and the second transmission shaft 20-4), and the energy storage turntable 20-5 drives the first spring 20-8 to travel from the first closed energy release position to the first critical position for energy storage; meanwhile, the operating shaft 20-1 drives the transmission plate 20-3 to move from the transmission plate closing position to the transmission plate breaking position; and meanwhile, the energy storage turntable 20-5 drives the output shaft structure to rotate from the output shaft closing position to the output shaft breaking position.
02: after the operating structure drives the first spring 20-8 to cross over the first critical position through the energy storage turntable 20-5, the first spring 20-8 travels toward the first breaking energy release position to release energy to drive the energy storage turntable 20-5 to rotate. During the above process, the energy storage turntable 20-5 abuts against the output shaft driven part 20-66 through the turntable third stopper 20-55, so as to drive it to rotate to the breaking transition position, and meanwhile, the transmission plate 20-3 and the output shaft structure cooperate to drive the second spring set to travel from the second closed energy release position to the breaking critical position and to cross over the breaking critical position. That is, the moment when the output shaft structure rotates to the breaking transition position and the second spring set travels to the breaking critical position is a moment after the first spring 20-8 travels to the first critical position and before the first spring 20-8 travels to the first breaking energy release position.
03: the second spring 30 travels toward the second breaking energy release position to release energy, so as to drive the output shaft structure to rotate to the output shaft breaking position.

As shown in FIGS. 2-3, when the operating mechanism is closed, an action process is as follows.

C1: the operating shaft 20-1 rotates in a closing direction (the closing direction is opposite to the opening direction each other) and drives the energy storage turntable 20-5 to rotate through the transmission shaft structure, and the energy storage turntable 20-5 drives the first spring 20-8 to travel from the first breaking energy release position to the first critical position for energy storage.

Meanwhile, the operating shaft 20-1 drives the transmission plate 20-3 to move from the transmission plate breaking position toward the transmission plate closing position. The transmission plate 20-3 abuts against the output shaft engaging part (the first output shaft connecting arm 20-65) through the transmission plate driving part 20-32, and drives the output shaft structure to rotate from the output shaft breaking position to the closing transition position. such that the output shaft driven part 20-66 of the output shaft structure is engaged with the turntable second stopper 20-54 of the energy storage turntable 20-5. Preferably, the output shaft driven part 20-66 is in contact with the turntable second stopper 20-54.

Meanwhile, the transmission plate 20-3 and the output shaft structure cooperate to make the second spring set travel from the second breaking energy release position to the second closed energy release position.

C2: the energy storage turntable 20-5 drives the first spring 20-8 to cross over the first critical position, and the first spring 20-8 releases energy to drive the energy storage turntable 20-5 to rotate.

Meanwhile, the energy storage turntable 20-5 abuts against the output shaft driven part 20-64 through the turntable second stopper 20-54, and drives the output shaft structure to rotate from the closing transition position to the output shaft closing position.

After the first spring 20-8 crosses over the first critical position, the transmission plate 20-3 and the output shaft structure cooperate to make the second spring set travel to the closed critical position for energy storage, then make the second spring set cross over the closed critical position, and the second spring travels toward the second closed energy release position and releases energy to drive the output shaft structure to rotate to the output shaft closing position. Meanwhile, the first spring 20-8 releases energy and drives the output shaft structure to rotate to the output shaft closing position through the energy storage turntable 20-5.

It should be explained that, in the description of the present invention, the terms such as “up”, “down”, “left”, “right”, “inner” and “outer” indicating the directional or positional relations on the basis of the directional or positional relations shown in the drawings are only used for conveniently describing the present invention and simplifying the description, not indicate or imply that the referred devices or elements must have a specific orientation and be configured and operated in a specific direction; therefore, they cannot be construed as a limitation on the present invention.

We have made further detailed description of the present invention mentioned above in combination with specific preferred embodiments, but it is not deemed that the specific embodiments of the present invention is only limited to these descriptions. A person skilled in the art can also, without departing from the concept of the present invention, make several simple deductions or substitutions, which all be deemed to fall within the protection scope of the present invention.

1. An operating mechanism, the operating mechanism comprises:
an operating shaft, which is driven to rotate by an external force;
a transmission shaft structure;
a transmission plate, which is driven by the operating shaft to move between a transmission plate breaking position and a transmission plate closing position;
a first energy storage structure, which comprises an energy storage turntable and at least one first spring engaged with the energy storage turntable, wherein the operating shaft drives the energy storage turntable to rotate through the transmission shaft structure; during the opening and closing processes of the operating mechanism, the first spring is driven by the energy storage turntable to store energy first and then release energy, and the first spring releases energy to drive the energy storage turntable to rotate;
an output shaft structure, which is engaged with the transmission plate and the energy storage turntable, moves between an output shaft breaking position and an output shaft closing position, and is in transmission connection with a contact system of a switching device; and
a second energy storage structure, which comprises a second spring set, wherein the second spring set comprises at least one second spring with both ends respectively engaging with the transmission plate and the output shaft structure, and when the operating mechanism is opened and closed, the transmission plate and the output shaft structure cooperate to make the second spring set store energy first and then release energy;
when the operating mechanism is opened:
the operating shaft drives the energy storage turntable and the transmission plate at the same time;
the transmission plate moves from the transmission plate closing position to the transmission plate breaking position;
the energy storage turntable drives the output shaft structure to rotate from the output shaft closing position toward the output shaft breaking position; after the first spring begins to release energy, the energy storage turntable (drives the output shaft structure to rotate to a breaking transition position and is disengaged from the output shaft structure after driving the output shaft structure to cross over the breaking transition position; meanwhile, the output shaft structure is engaged with the transmission plate, such that the second spring set completes energy storage and then begins to release energy; and
the second spring set releases energy and drives the output shaft structure to rotate to the output shaft breaking position.

2. The operating mechanism according to claim 1, wherein
when the operating mechanism is closed;
the operating shaft drives the energy storage turntable and the transmission plate simultaneously;
the energy storage turntable rotates and drives the first spring to store energy, and meanwhile, the transmission plate moves from the transmission plate breaking position toward the transmission plate closing position;
the transmission plate drives the output shaft structure to rotate from the output shaft breaking position toward the output shaft closing position; when the first spring (completes energy storage, the transmission plate drives the output shaft structure to rotate to a closing transition position, such that the output shaft structure is in transmission fit with the energy storage turntable; and
the first spring releases energy and drives the output shaft structure to rotate to the output shaft closing position through the energy storage turntable.

3. The operating mechanism according to claim 1, wherein a moving direction of the transmission plate is perpendicular to a rotational axis of the output shaft structure.

4. The operating mechanism according to claim 1, wherein a moving direction of the transmission plate is perpendicular to a rotational axis of the operating shaft, and a rotational axis of the output shaft structure is perpendicular to the rotational axis of the operating shaft and is parallel to a plane where the transmission plate is located.

5. The operating mechanism according to claim 1, wherein one end of the transmission shaft structure is in transmission fit with the operating shaft, and another end of the transmission shaft structure is in transmission fit with the energy storage turntable.

6. The operating mechanism according to claim 5, wherein a rotational axis of the transmission shaft structure and a rotational axis of the operating shaft are spaced in parallel.

7. The operating mechanism according to claim 1, wherein the transmission shaft structure comprises a first transmission shaft and a second transmission shaft that are coaxially arranged and rotate synchronously; one end of the first transmission shaft is in transmission fit with the operating shaft, and another end of the first transmission shaft is fixedly connected to or in transmission fit with the second transmission shaft; the second transmission shaft is in transmission fit with the energy storage turntable; and
the operating shaft comprises an operating shaft main body and an operating shaft first gear, wherein the operating shaft first gear is arranged on the operating shaft main body; the first transmission shaft comprises a first transmission shaft main body and a first transmission shaft gear; the first transmission shaft gear is arranged on the first transmission shaft main body; and the operating shaft first gear is meshed with the first transmission shaft gear.

8. The operating mechanism according to claim 1, wherein the transmission plate comprises a transmission plate toothed belt; the operating shaft comprises an operating shaft second gear; the operating shaft second gear is arranged on the operating shaft main body of the operating shaft; and the transmission plate toothed belt is meshed with the operating shaft second gear.

9. The operating mechanism according to claim 2, wherein the transmission plate comprises a transmission plate driving part; the output shaft structure comprises an output shaft engaging part; and the transmission plate driving part drives the output shaft structure to rotate through the output shaft engaging part.

10. The operating mechanism according to claim 1, wherein the transmission plate comprises a transmission plate connecting arm, one end of the second spring is rotatably connected to the transmission plate connecting arm, and another of the second spring is rotatably connected to the output shaft structure; and
the second energy storage structure comprises two second springs, and the two second springs are arranged in parallel; each second spring comprises a second spring coil body and second spring connecting arms that are respectively arranged at both ends of the second spring coil body; one of the second spring connecting arms is rotatably connected to the output shaft structure, and another one of the second spring connecting arms is rotatably connected to the transmission plate connecting arm.

11. The operating mechanism according to claim 1, wherein the transmission plate comprises a transmission plate main body, a transmission plate toothed belt, a transmission plate driving part and a transmission plate connecting arm; the transmission plate main body is of a frame-shaped structure; the transmission plate main body is provided with a first side edge and a second side edge which are parallel to a moving direction of the transmission plate main body; the transmission plate toothed belt is arranged on an inner side surface of the first side edge; the first side edge and the second side edge are respectively provided with a transmission plate connecting arm; the two transmission plate connecting arms are opposite to each other; the transmission plate driving part is arranged on the second side edge and is opposite to the transmission plate toothed belt; and the transmission plate driving part and the two transmission plate connecting arms are positioned on the same side of the transmission plate main body.

12. The operating mechanism according to claim 2, wherein the energy storage turntable comprises a turntable main body, as well as a turntable first stopper and a turntable second stopper that are respectively arranged on the turntable main body and distributed in a circumferential direction of the turntable main body; the energy storage turntable is rotatably arranged around an axis of the turntable main body; the transmission shaft structure comprises a transmission shaft shifting rod; the transmission shaft shifting rod is position between the turntable first stopper and the turntable second stopper; the transmission shaft shifting rod and the turntable first stopper are engaged to drive the energy storage turntable to rotate, and the energy storage turntable drives the first spring to travel from a first closed energy release position toward a first critical position; the transmission shaft shifting rod and the turntable second stopper are engaged to drive the energy storage turntable to rotate, and the energy storage turntable drives the first spring to travel from a first breaking energy release position toward a first critical position.

13. The operating mechanism according to claim 12, wherein the energy storage turntable further comprises a turntable third stopper arranged on the turntable main body; the turntable first stopper, the turntable second stopper and the turntable third stopper are sequentially distributed in a circumferential direction of the turntable main body; the output shaft structure further comprises an output shaft driven part; when the operating mechanism is opened, the turntable third stopper abuts against the output shaft driven part, such that the output shaft structure rotates from the output shaft closing position to the breaking transition position; and when the operating mechanism is closed, the turntable second stopper abuts against the output shaft driven part, such that the output shaft structure rotates from the closing transition position to the output shaft closing position.

14. The operating mechanism according to claim 1, wherein the output shaft structure comprises a first output shaft and a second output shaft that are coaxially arranged and synchronously rotate; the first output shaft comprises a first output shaft connecting part and a first output shaft outputting part; the second output shaft comprises a second output shaft connecting part and a second output shaft outputting part; the first output shaft connecting part is fixedly connected to the second output shaft connecting part; at least one of the first output shaft outputting part and the second output shaft outputting part is used for driving connection with the contact system of the switching device; and
the output shaft structure further comprises the output shaft driven part and an output shaft engaging part, and the output shaft driven part and the output shaft engaging part are respectively arranged on the first output shaft connecting part and are distributed in a circumferential direction of the first output shaft connecting part.

15. A switching device, wherein the switching device comprises the operating mechanism according to claim 1.
